(19) United States
(12) Patent Application Publication
(10) Pub. No.: US 2005/0240467 A1
(43) Pub. Date: Oct. 27, 2005

(54) Systems and methods for selective sharing of business performance information

(75) Inventors: Loren Eckart, Atlanta, GA (US); Robert Woosley, Atlanta, GA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Illumen, Inc., Atlanta, GA (US)

(21) Appl. No.: 10/893,495

(22) Filed: Jul. 19, 2004

Related U.S. Application Data
(63) Continuation-in-part of application No. 10/830,115, filed on Apr. 23, 2004.

(51) Int. Cl. G06F 17/60

(52) U.S. Cl. 705/10

(57) ABSTRACT

An automated system for allowing a submitter business to selectively share business performance information with requestor businesses through a business performance information sharing data center computer system over the Internet. A submitter business uploads a data file including business performance information such as a trial balance report generated by the business' own accounting software program. The uploaded file is converted from the submitter-defined format to a standardized format. Various business performance data analyses are performed on the standardized data including generating standardized business performance reports and analyzing the data in accordance with financial metrics. After the business performance data has been formatted and analyzed, the submitter will specify one or more companies authorized to view the business performance data including specifying a level of business performance detail, from a plurality of levels of detail, and/or a business performance time period for which that company may view business performance information.

### CROSS REFERENCE TO RELATED APPLICATIONS

This application is a continuation-in-part of related application Ser. No. 09/______, filed Apr. 24, 2004, entitled, “Automated Management of Business Performance Information,” the disclosure of which is hereby incorporated by reference in its entirety.

### FIELD OF THE INVENTION

The present invention relates generally to automated processing of business performance information and more particularly to an automated business performance data management system for permitting businesses to selectively share their business performance information with interested parties.

### BACKGROUND OF THE INVENTION

Business performance information has become extremely important in today's business marketplace both in making credit decisions and in establishing reciprocal trade relationships between companies. Banks, CPA firms, corporations, credit companies, insurers and other underwriters have a need to monitor business performance information of their customers in order to minimize risk and avoid financial surprises. Moreover, the stability of manufacturing and service providing companies is often dependent on one or more key component(s) or services suppliers. Financial or operating problems at these suppliers could cause a chain reaction which adversely affects their business partners. As a result, manufacturing and service companies also have a need to review business performance information of suppliers and other partner businesses upon which they are dependent in order to insure that their future business operations remain stable.

Unfortunately, the process of gathering and monitoring business performance information on businesses has been highly labor intensive and often produced inaccurate results. Financial information on publicly traded companies is easily obtainable due to the standardization of financial record keeping in accordance with generally accepted accounting principles (GAAP) and quarterly filing and disclosure requirements imposed by the U.S. Securities and Exchange Commission (SEC). However, for partnerships and other private business ventures, obtaining accurate and standardized financial information is much more difficult. Private businesses typically maintain their own financial records on site, or through the assistance of an outside accountant using one of a number of commercial off the shelf (COTS) financial accounting software programs. Such software programs include but are not limited to, QUICKBOOKS, SOLOMON, and PEACHTREE and are ubiquitously well known in the accounting profession. All of these programs, in one form or another, maintain financial records including balance sheets, income statements, individual account statements and other well known financial records.

As a result of the decentralized and unreported nature of small or private business financial information, it is often difficult for interested parties to obtain standardized financial information on businesses that they are or may be interested in doing business with or to perform relevant comparisons between similarly situated businesses. Typically, companies in such a position will utilize a financial data gathering service such as Dun & Bradstreet to perform a report summarizing any known financial information about the business of interest. Such a report has come to be known in the profession as a “D & B.” A problem with this type of financial reporting is that information obtained by these financial information gathering firms is largely obtained through solicitation from the company itself. Once this self-reported information gets into the information gathering firm's possession, the submitting company no longer has control over its distribution. As a result, companies are generally reluctant to provide full disclosure, and may even be incentivized to mislead companies seeking to gather information on them. Also, because financial data gathering firms must rely on the willingness of businesses to disclose information to them, it is unlikely that uniform information will be available for all reporting companies. As a result, a consumer of such information will have difficulty in making a balanced comparison between two or more similarly situated business based on financial metrics. Another problem with conventional financial data gathering firms is that the data collection method may be disjointed, consisting of various sources which must be manually assimilated into a format that is valuable to consumers of such information. This is a labor intensive process which increases the ultimate cost for such information and likely reduces its accuracy.

Accordingly, there is a need for an improved system for sharing financial information of businesses with interested parties which ameliorates or overcomes the deficiencies of known systems.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, transparent operation, cost savings, etc.

In accordance with one exemplary embodiment of this invention, a method for sharing business performance data of a submitter business with one or more requestor businesses is provided. The method according to this embodiment comprises generating at least one business performance report based on data associated with a submitter business on a computer system, uploading the at least one business performance report to a data center computer system via a communications network, converting, using a process executed by the data center computer system, the at least one business performance report from a first format to a second format, and receiving an instruction from the submitter business indicative of at least one requestor business authorized to view the at least one business performance report associated with the submitter business in the second format over the communications network.

In accordance with another exemplary embodiment of this invention, a method for sharing business performance data of a submitter business with one or more requestor businesses is provided. The method according to this embodiment comprises generating, with a software program executing on a computer system, at least one business performance report comprising business performance data of a submitter business in a first data format. The method also comprises, using a graphical user interface, uploading the at least one report to a data center computer system via the Internet, converting, using a process executed by the data center computer system, the at least one report from the first data format into a second data format, and receiving an indication from the submitter business, through the graphical user interface, of at least one requestor business authorized to view the at least one report in the second data format over the Internet.

In accordance with yet another exemplary embodiment of this invention, a system for automated sharing of business performance information between a submitter business and at least one requestor business is provided. The system according to this embodiment comprises at least one data center computer system that is configured to operate at least one Internet web site displaying one or more Internet web pages, to receive business performance information associated with a submitter business via data upload of at least one business performance report from the submitter business over the Internet, the at least one report being formatted in a first data format. The data system computer system according to this embodiment is also configured to convert the at least one business performance report into a second data format using software instructions executing on the data center computer system, to request and receive an indication from the submitter business of at least one requestor business that is authorized to view the at least one business performance report, and to display the at least one business performance report to the at least one authorized requester business in the second data format over the Internet.

Yet another exemplary embodiment according to this invention provides, in an environment comprising a plurality of submitter businesses, each submitter business associated with at least one submitter business computer system, a data center computer system, and a plurality of requestor businesses, each requester business associated with at least one requestor business computer system, the submitter business computer system and the requestor business computer system connected to the data center computer system via a communications network, a system for selectively sharing business performance information of a submitter business with at least one requestor business. The system according to this embodiment comprises at least one data center computer system that in turn comprises a means for electronically receiving over a communications network at least one business performance report associated with a submitter business, the at least one business performance report being in a first data format, automated means for converting the at least one business performance report into a second data format, means for receiving an indication from the submitter business of at least one requestor business authorized to view said business performance report, and means for displaying the at least one business performance report to the at least one authorized requester business in the second data format over the communications network.

In still a further exemplary embodiment according to this invention, a method for encouraging submitter businesses to share business performance information with requestor businesses through a financial information sharing network is provided. The method according to this embodiment comprises receiving at a data center computer system a request from a requestor business for information on at least one submitter business providing a specific business service and meeting one or more financial criteria, sending an electronic request to the at least one submitter business requesting that the submitter business allow the requestor business to view the submitter's business performance information, and based on a received affirmative response to the request, allowing the requester business to view the business performance information of the submitter business.

In still one additional exemplary embodiment according to this invention, a data center computer system comprising a computer readable storage medium containing computer readable instructions executable by a processor, the instructions configured to enable a submitter business to share business performance information with at least one requestor business is provided. The computer readable storage medium according to this embodiment comprises instructions for receiving a data upload comprising business performance data corresponding to a submitter business in the form of a business performance report in a first data format, instructions for converting the business performance report into a second data format, instructions for requesting and receiving identification of at least one requester business authorized by the submitter business to view the business performance report, and instructions for displaying the business performance report to the at least one requestor business in the second data format.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic diagram illustrating the components of a network-based business performance information sharing system according to various exemplary embodiments of this invention;

FIG. 2 is a flow chart illustrating the steps of a method for a submitter to interact with a network-based business performance information sharing system according to various exemplary embodiments of this invention;

FIG. 3, is a graphic image illustrating a secure login browser window for securely logging in to a network-based business performance information sharing system according to various exemplary embodiments of this invention;

FIG. 4 is a graphic image illustrating a business performance information upload browser window for uploading business performance information to a network-based business performance information sharing system according to various exemplary embodiments of this invention;

FIG. 5 is a print out of a business performance information file in a submitter-defined format for upload to a network-based business performance information sharing system according to various exemplary embodiments of this invention;

FIG. 6 is a graphic image illustrating a confirmation message sent to a submitter after a successful business performance data file upload to the network-based business performance information sharing system has occurred according to various exemplary embodiments of this invention;

FIG. 7 is a graphic image of a exemplary interactive financial dashboard presenting business performance data of a submitter business in a combined text and graphic format generated by a network-based business performance information sharing system according to various embodiments of this invention;

FIG. 8 is a graphic image illustrating a requester approval browser window for permitting a submitter to authorize third party requestors to view their business performance information, including multiple levels of access and frequency of data updates, from the network-based business performance information sharing system in accordance with various exemplary embodiments of this invention.

FIG. 9 is a flow chart illustrating the steps of a method for a requester to interact with a network-based business performance information sharing system according to various exemplary embodiments of this invention;

FIG. 10 is a graphic image of a interactive requestor dashboard browser window for viewing submitter business performance information over a network-based business performance information sharing system according to various exemplary embodiments of this invention;

FIG. 11 is full financial report based on submitter business performance data created by a network-based business performance information sharing system according to various exemplary embodiments of this invention;

FIG. 12 is an account detail drill down report including individual account entries created by a network-based business performance information sharing system according to various exemplary embodiments of this invention;

FIG. 13 is a financial summary browser window created by a network-based business performance information sharing system according to various exemplary embodiments of this invention;

FIG. 14 is a graphic image of a message window to a submitter company from a requester company including a graphic image taken from the submitter's business performance data stored in the network-based business performance information sharing network according to various exemplary embodiments of this invention; and

FIG. 15 is block diagram illustrating the internal components of a network-based business performance information sharing system according to various exemplary embodiments of this invention.

### DETAILED DESCRIPTION OF THE INVENTION

The following description is intended to convey a thorough understanding of the present invention by providing a number of specific embodiments and details involving an automated system for standardizing, analyzing, maintaining and selectively sharing business performance information. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

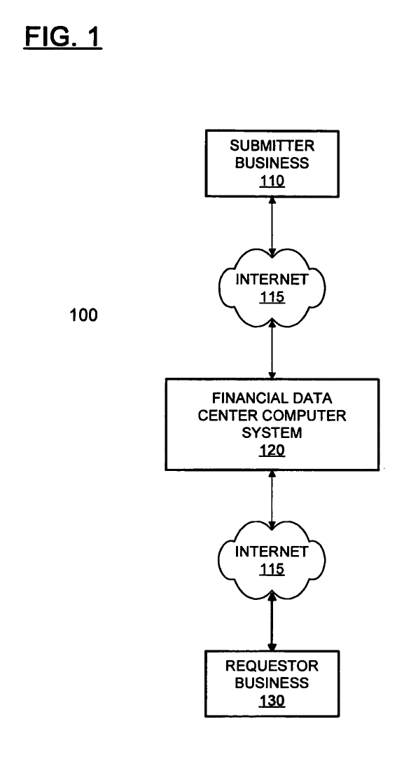

FIGS. 1-15 illustrate exemplary systems and methods for accumulating, standardizing, analyzing and presenting business performance data over a communications network. Business performance data may include, but is not limited to financial information related to a business including net income, gross sales receipts, total assets, total liabilities, cash, and the like. Business performance data may also include combinations of financial and operation information such as revenue per employee, gross margin per store, etc. In various exemplary embodiments according to this invention, business performance data is maintained by an individual business using one of various COTS accounting software programs.

In various exemplary embodiments of the systems and methods according to this invention, using COTS accounting software, a business may export performance information in the form of, for example, a trial balance worksheet, which provides debit and credit balances for all balance sheet and income statement accounts to a file and will submit this information to the business performance information sharing system of the present invention. As is known in the art, a trial balance is a worksheet listing all general ledger accounts and their debit or credit balance. Using a conversion mapping process, the business performance information is standardized by converting from the submitter-defined format to a standardized format. In various exemplary embodiments, mapping of the business performance information is performed by a process including a combination of one or more operator processes and one or more automated processes. In various other exemplary embodiments, the mapping of business performance information is performed by a completely automated process performed using one or more software programs. Various analysis techniques may be performed on the converted business performance information, either in aggregation or for a particular business, and one or more performance reports and/or alerts may be generated from the results of the analysis. These analysis techniques and performance report generation also may be implemented as automated processes using one or more software programs.

In various exemplary embodiments, the system of the present invention will convert this submitter's business performance information to a graphical data presentation and perform financial analysis on the business performance information in accordance with various known financial analysis techniques, including analyzing the financial information using one or more financial metrics. The term “financial metrics,” as used herein, generally refers to a standard of measurement used in the financial and accounting sector to indicate the profitability, efficiency, stability, vulnerability, etc. of a business. Financial metrics may include snapshot metrics such as cash on hand, current ratio, etc. Financial metrics may include aggregate metrics such as net profits, net sales, etc. Financial metrics may also include derivative metrics such as revenue growth, earnings growth, etc. that require a rate of growth calculation. Unless otherwise noted, the use of the term financial metrics applies to snapshot metrics, aggregate metrics and derivative metrics as well as any other generally accepted categories of metrics. The standardized business information may be aggregated based on various classifications of the business. From a portion of all of the aggregated information, one or more performance metrics representative of the average or collective performance of the business may be identified. Business performance information from a particular business then may be compared to the representative performance metrics to benchmark the performance of the particular business relative to similar businesses.

The term “business,” in the context of a submitter of performance information, as used herein and for the purposes of example, will be used to refer to a private business venture, including but not limited to a private corporation, partnership or other business entity. For the purposes of this specification and claims, businesses are the submitters of financial information to the financial information sharing network. However, it should be appreciated that the present invention may also be applicable to public corporations and/or non-for-profit organizations, government organizations and quasi-government organizations. That is, any of these entities may be submitter businesses as well. The term “requester business” as used herein, will be used to refer to businesses that either request performance information on or receive performance information from submitter businesses. These terms will be used to refer to any business entity, public or private, financial institution, or other entity separate from the submitter business, that is interested in or invited to view business performance information on one or more submitter businesses.

It is important to note that in all embodiments of this invention, submitters of business performance information to the financial information sharing network are always in control over which requestors are able to view their business performance information. The submitters must explicitly approve each and every requester before a requestor may view business performance information of that submitter. In various exemplary embodiments, the submitter will also specify, for each approved requester, a level of information from a plurality of levels, that may be viewed by that requestor. In various exemplary embodiments, the submitter will also specify, for each approved requestor, a business period for which financial information may be viewed by that requester. For example, this may include specifying only financial data for the most recent quarter, month, or annual period. In various exemplary embodiments, the submitter will also specify, for each approved requester, a frequency with which financial information will be updated for that approved requester, for example, every month, every quarter, or every year, or even every time the submitter uploads new business performance information. It should be appreciated, that while conventional business performance reporting is based on monthly, quarterly and annual reporting periods, the frequency could also be weekly, daily and even in real time, that is as financial transactions occur. At no time may requestors view business performance information of a submitter without that submitter's previously granting permission to that requester. Furthermore, a submitter may, at any point, revoke a requestor's right to view his business performance information or change the level of access previously granted to a requestor. Through these safeguards, submitters of business performance information may be assured that they are always in control of the dissemination of their business performance information.

As discussed briefly above, for purposes of example and ease of illustration, the present invention is described herein in the context of formatting, analyzing, maintaining, and sharing of business performance information provided by private businesses. However, it should be appreciated that the exemplary systems and methods discussed herein may be adapted to sharing business performance information for other business entities as well. Indeed, the present invention could be implemented to share business performance information on public corporations, non-profit organizations, government agencies and other entities without departing from the spirit or scope of this invention.

For ease of illustration and simplicity, FIGS. 1-15 illustrates embodiments of the invention in terms of a generic and substantially standardized submitter and requestor interface. However, it should be appreciated that various embodiments of the invention may incorporate an interface that has been customized for a specific participating business, typically, though not necessarily for a requester business. Such a customized interface may include, but should not be limited to, presentation of graphic images incorporating marks associated with the specific participating business, a data center web address that is customized for the specific participating business, data mapping and analysis functions that are selected by a specific participating business, a business information presentation screen that has fields and financial metrics that are customized in accordance with preferences of the specific participating business, electronic links to other web pages associated with and/or maintained by the specific participating business, and other specific participating business customizations and/or branding. For example, the specific participating business may comprise a large financial services company which does business with thousands of small submitter businesses. When accessing the system according to this invention, both submitter companies and members of the large financial services company interacting with the financial information sharing system will be presented with a branded interface. In various embodiments of the present invention, several specific participating businesses may each have their own “brand specific” front end interface to the business performance information sharing system, while the business performance information sharing system provides the back end functionality to each.

Referring now to FIG. 1, FIG. 1 is a schematic diagram illustrating the components of a network-based business performance information sharing system according to various exemplary embodiments of this invention. As shown in FIG. 1, the network-based business performance information sharing system 100 is comprised of a submitter business computer system 110, a business performance data center computer system 120 and a requestor business computer system 130. The submitter business computer system 110 and the requestor business computer system 130 interact with the data center computer system 120 via a communications network, for example, as shown in FIG. 1, the Internet. For ease of illustration, FIG. 1 represents the submitter business and the requestor business each as a single computer system. However, any number of computer systems which are able to access the business performance data center computer system 120 may serve as either submitter or business computer systems. It is the identification information of the operator logging into the business performance data center computer system 120 which determines the classification of either submitter or requester. In addition, for ease of illustration, only a single submitter business 110 and requester business 130 are shown in the Figure. In practical application, however, there will be a plurality of submitter businesses 110 and a plurality of requestor businesses 130. Moreover, though the business performance data center computer system 120 is shown as a single server computer system, the business performance data center computer system 120 may comprise several server computer systems or even a distributed network of server computer systems. The specific network topology of the business performance data center computer system 100 is not critical to the present invention. Indeed, the present invention will be compatible with various network topologies so long as the business performance information data center computer system 100 may be conveniently accessed over a communications network.

With continued reference to FIG. 1, the Internet 115 serves as the gateway between the submitter business 110 and the requestor business 130. As will be discussed in greater detail herein, maintaining business performance data centrally and permitting interaction over the Internet permits quick and efficient uploading and viewing of business performance information. Utilizing email messages, the data center computer system may notify requesters that they have been authorized to view business performance information of a submitter by including a click through link in the email messages which routes the requesters back to a login screen at the data center computer system 120. Alternatively, the business performance data center computer system 120 may notify submitters that one or more requestors would like to view their business performance information over the business performance information sharing network 100. Such a notification may be effected by an interactive email message that includes a click through link to facilitate participation of that submitter in the business performance information sharing network or requesting that the submitter grant permission to view its business performance information to one or more requesters.

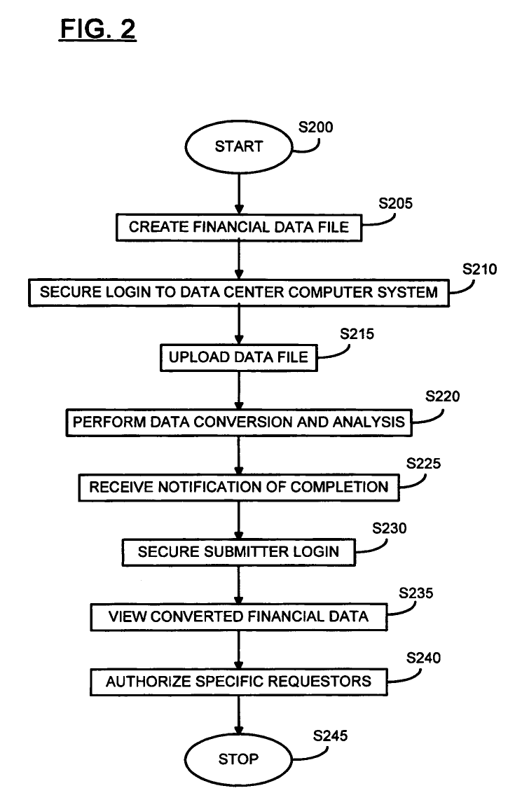

Referring now to FIG. 2, FIG. 2 is a flow chart illustrating the steps of a method for a submitter to interact with a network-based business performance information sharing system according to various exemplary embodiments of this invention. Operation of the method begins in step S200 and proceeds to step S205, where a potential submitter of business performance information to the business performance information sharing data center computer system of the present invention creates a business performance report file. As discussed above, this step S205 will typically be performed by an operator at the business entity corresponding to the business performance data. Most, if not all, COTS accounting software programs have a data export function that allows data from either the general ledger or various sub statements to be exported to a spreadsheet file format or a text file format. In a preferred embodiment, the business performance information will be a trial balance statement. As noted above, a trial balance statement is a worksheet listing all general ledger accounts and their debit or credit balance. In various other embodiments, the business performance report file may be provided in a raw format or may be arranged in any of a variety of performance reporting formats, such as ledgers, income statements, balance sheets, operation specifications, etc. Preferably, the business performance report file is provided in electronic form and in a file format used by any number of the COTS accounting software programs. A copy of this electronic file will be saved locally. However, in other embodiments, the business performance report file may be provided in hard-copy format (e.g., a print out of the general ledger, income statement, balance sheet and/or cash flow statement), and the information represented on the hard copies may be converted to electronic form by for the business performance information sharing data center computer system by manual entry or by using an optical character recognition (OCR) scanning process.

After the step of creating the business performance information file associated with the submitter business is completed, operation of the method proceeds to step S210 where the submitter logs in to a secure website associated with the business performance information sharing data center computer system of the present invention. After the user has been authenticated, operation of the method proceeds to step S215, where the user is prompted to upload his business performance report file to the business performance data center computer system of the business performance information sharing system. In a preferred embodiment, this step comprises uploading the business performance information through a web page including an upload link. In an alternative embodiment, this step may comprise sending the file to the data center computer system using a file transfer protocol application (FrP). In yet another alternative embodiment, this step may comprise attaching the business performance information file to an electronic mail message and sending it to an electronic mail address associated with the business performance information sharing data center computer system. If, as discussed above, the business performance information file is not in an electronic format, this step will require one of faxing a printout of the business performance information file, mailing a hard copy of the business performance information file or otherwise delivering a physical copy of the business performance information to an agent associated with the business performance information sharing data center computer system so that it may be entered to the data center computer system, through either a manual or electronic data entry process.

Once the business performance data file has been successfully uploaded, processing proceeds to step S220 where data conversion is performed by the business performance data center computer system. As will be discussed in greater detail herein, in various exemplary embodiments, the data conversion process converts the data from the submitter-defined format into a standardized format including a combination of text and graphics using a conversion mapping process preferably performed using one or more software programs. Furthermore, in various exemplary embodiments, one or more financial data analyses are performed on the data including calculating one or more financial metrics based on the business performance data.

By converting the business performance information to a standardized format, analyzing the business performance information, and generating one or more performance reports using one or more automated processes, the business performance information sharing data center computer system can assist requesting parties in their review of the performance of submitter business by allowing the requestor to review the results of the financial analysis in a familiar, organized and accurate format and in a fraction of the time required by conventional techniques. As a result, there may be tremendous cost savings on an on-going basis. Moreover, the quick turn around afforded by the business performance information sharing data center computer system of the present invention facilitates the identification of potential problems while they are still in a formative stage, thereby allowing them to be addressed and/or corrected before they become irreversible. As an example, conventional performance analysis techniques may take weeks to turn around due to the manual effort involved in converting business performance information to a standard format that can be analyzed in a consistent and meaningful way, in addition to the time required to generate performance reports and/or benchmarking from the analysis. Thus, a business having a rapid decline in its cash account and a rapid increase in its accounts payable may find itself unable to make debt payments and payment to its trade accounts if a number of weeks pass before this condition is realized. However, because the business performance information sharing data center computer system may provide meaningful analysis within minutes, or even seconds, of receiving business performance information from a submitter business, such situations may be quickly identified.

With continued reference to the method illustrated in FIG. 2, next, in step S225, after the data has been converted, a notification is sent to the submitter of the data, informing him that the data conversion process is complete and inviting him to return to the business performance data center computer system to view the converted business performance information. In various exemplary embodiments, the notification will comprise an email containing a link to click through to the business performance data computer center computer system. However, the notification may also comprise a facsimile notification, a telephone notification, a regular mail notification or other suitable notification mechanism. Then, in step S230, utilizing a web browser, the submitter will return to the web site associated with the business performance information sharing data center computer system and log in to the secure server. Next, in step S235, after the identity of the submitter has been authenticated, the submitter is presented with a view of his converted business performance information. In various exemplary embodiments, and as will be discussed in greater detail herein, the operator will be presented with an interactive financial dashboard view of his business performance information including a combination of text and graphics. Operation of the method then proceeds to step S240 where the submitter is prompted to authorize one or more specific requestor businesses to view his business performance information. In various exemplary embodiments and as will be discussed in greater detail herein, in this step, the user will also select, for each authorized viewer, a level of financial information authorized from a plurality of levels ranging from a summary to individual entry level data. Furthermore, in various exemplary embodiments, the user will also specify the periodicity with which his business performance data is updated for each authorized viewer. Operation of the method terminates in step S245.

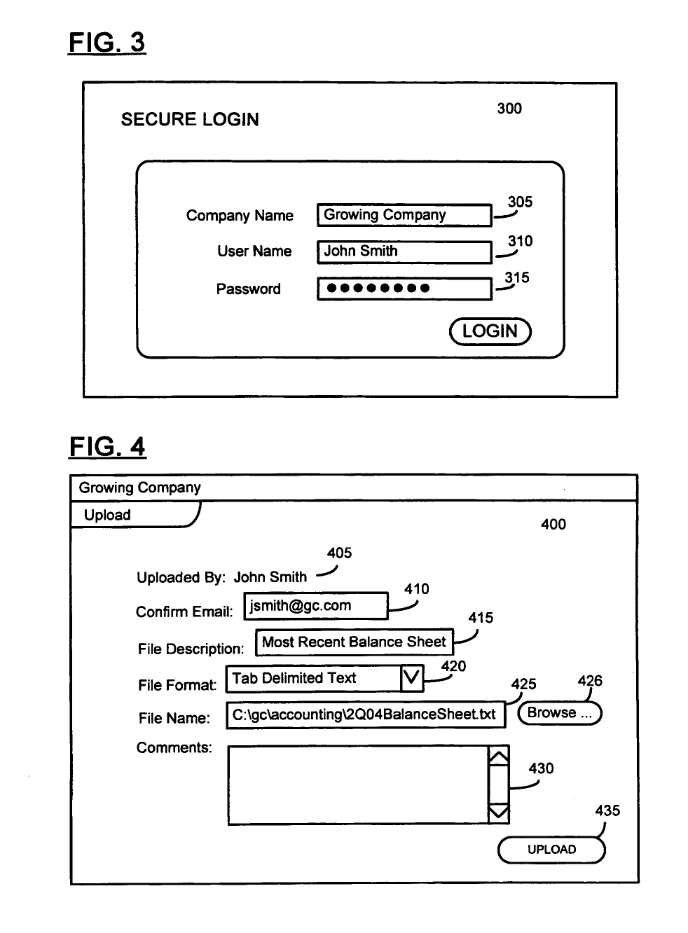

Referring now to FIG. 3, FIG. 3 is a graphic image illustrating a secure login browser window for securely logging in to a network-based business performance information sharing system according to various exemplary embodiments of this invention. In a preferred embodiment, the login screen 300 shown in FIG. 3 will be presented to the submitter through his Internet browser software application after selecting a login link on a web page associated with the business performance information sharing data center computer system of the present invention. As illustrated in FIG. 3, the secure login screen 300 comprises a Company Name entry field 305, a User Name entry field 310 and a Password entry field 315. It should be appreciated that the format of the secure login screen 300 shown in FIG. 3 is exemplary only. The specific design of the login screen is not critical to the invention. In fact, any number of different log in screens may be utilized. In various exemplary embodiments, the submitter will have already registered with the business performance information sharing system prior to logging in through the secure login screen 300. Thus, if the submitter has previously registered, the login screen 300 merely permits authentication of the person logging on against the previously stored information for that person and/or business entity. Otherwise, if the submitter has not previously registered, the submitter will be directed to a screen enabling him to electronically register his business to participate in the business performance information sharing system of the present invention. Also, in various exemplary embodiments, upon registering with the business performance information sharing system, a submitter will identify several persons associated with the submitter business who are authorized to interact with the business performance information sharing system. Thus, for a given company name, there may be a plurality of different operator credentials which may be entered to effect login. This holds true for requestor businesses as well. That is that for a given participating requestor, there may be multiple persons associated with that requestor who may log into the system.

FIG. 4 is a graphic image illustrating a business performance information upload browser window for uploading business performance information to a network-based business performance information sharing system according to various exemplary embodiments of this invention. The upload window 400 shown in FIG. 4 includes various fields used to characterize the business performance information and includes an interactive button to specify a location of the electronic file containing the submitter's business performance information. As illustrated in FIG. 4, the upload window 400 comprises a plurality of data fields including a submitter name field 405, a confirm email field 410, a file description field 415, a file format field 420, a filed name (path) field 425 with a browse button 426 and a comments field 430. It should be appreciated that the fields shown in FIG. 4 are exemplary only and should not be interpreted as an exhaustive list. In various embodiments, it may be desirable to use more or less fields or even different fields altogether. Moreover, as discussed above, an information upload screen is not the only means of uploading business performance information to the network that is contemplated with this invention. Various other methods including, email attachment, faxing, FTP, manual data entry and combinations thereof may also be utilized.

In various exemplary embodiments, the upload by field 405 will be pre-populated using credentials supplied by the submitter to the secure login screen. However, in various other embodiments, this field will be user definable. In various exemplary embodiments, and both as a security precaution and to permit the use of different email addresses, the value entered into the confirm email field 410 will be compared against previously stored email information for that submitter. In a preferred embodiment, the file format field 420 will be a drop down field containing a list of acceptable file formats. The data supplied by the submitter in this field will be used during data conversion and mapping to insure that the correct conversion process is utilized. By selecting the browse button, the submitter may navigate through his available drives to find the correct path and file name of the file containing the business performance information. Such buttons are typically employed in data upload operations to prevent errors due to erroneous entry of the file path and/or name. Finally, the comments field 430 will provide an opportunity for the submitter to leave any messages or explanations to be viewed by requesters of the submitter's business performance data. In various exemplary embodiments, the comments input into this field by the submitter will be in the nature of the “Management Discussion and Analysis of Financial Condition and Results of Operations” comments typically included with public company quarterly and annual financial filings. Once appropriate values have been entered by the submitter for each of the fields of the upload window 400, the submitter selects the upload button 435 to initiate the upload process. In a preferred embodiment, once the upload has been successfully completed, the business performance information sharing data center computer system will automatically send a confirmation message to the email address supplied by the submitter on the upload window 400 indicating that upload was a success.

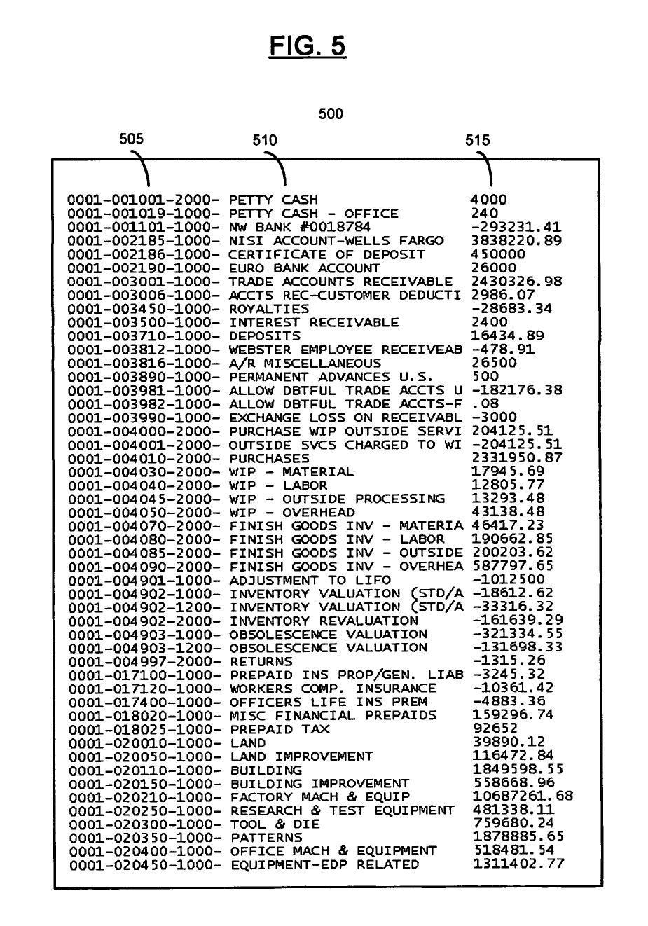

Referring now to FIG. 5, FIG. 5 is a print out of a business performance information file in a submitter-defined format for upload to a network-based business performance information sharing system according to various exemplary embodiments of this invention. As shown in FIG. 5, the business performance information file 500 comprises a trial balance formatted as a text file containing three columns of tab delimited text entries of business performance information of a business to be used with the business performance information sharing system in accordance with various embodiments of this invention. As discussed above, the text file 500 may be generated using any one of the available COTS accounting programs and may include data from any table, ledger, balance sheet or other financial form available in the accounting software program. Also, although the trial balance shown in FIG. 5 is formatted as a tab delimited text file 500, alternatively, a character delimited text file, a spread sheet file, a word processing document file, a proprietary accounting software program file or other file format may be used without departing from the spirit or scope of this invention. Moreover, it may be advantageous to substitute another financial worksheet for the trial balance depending on the submitter's desired level of financial disclosure.

With continued reference to FIG. 5, each data entry in the trial balance text file 500 consists of an account number field 505, an account name field 510 and an account balance field 515. It should be noted that although the business performance information file 500 shown in FIG. 5 shows only three fields, it may be desirable to include more or less fields for each entry. In fact, the use of three fields in FIG. 5 is for exemplary purposes only. The present invention is compatible with both more or less fields per table entry. As shown in FIG. 5, the account number field 505 may include two or more portions, a first portion identifying a unique number associated with that entry and the second identifying whether the entry describes an asset account or a liability account.

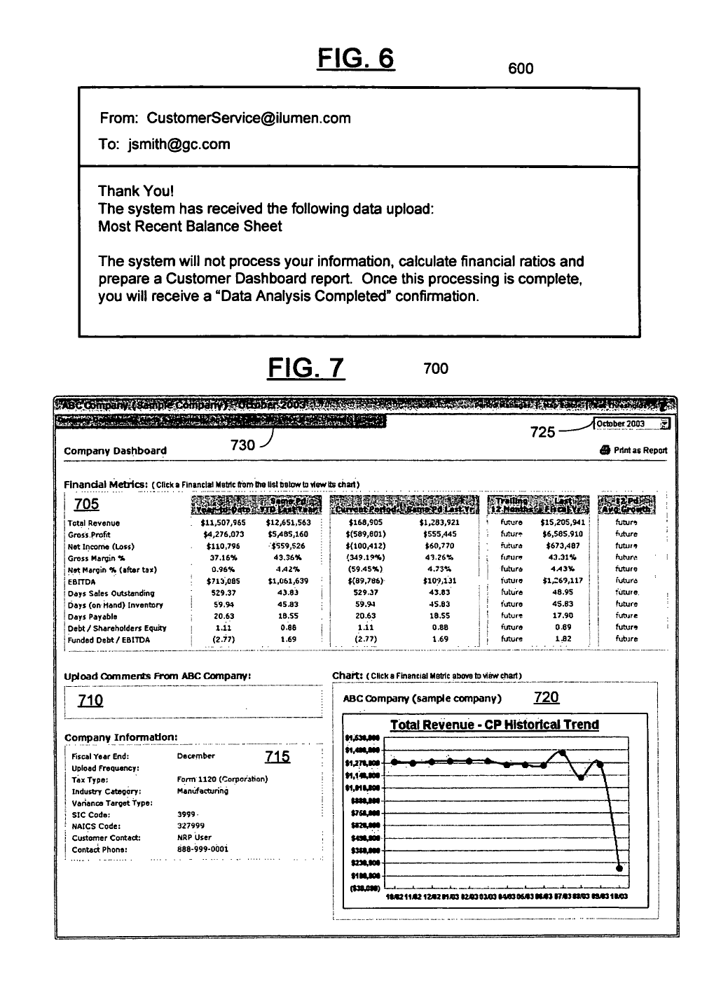

Now referring to FIG. 6, FIG. 6 is a graphic image illustrating a confirmation message sent to a submitter after a successful business performance data file upload to the network-based business performance information sharing system has occurred according to various exemplary embodiments of this invention. As discussed above, in the context of FIG. 4, this message is preferably sent automatically by the data center computer system upon completion of the data upload to notify the user that the business performance data file has been successfully uploaded. In the embodiment illustrated in FIG. 6, the message 600 is sent as an email message. However, in alternative embodiments, the message may appear directly in submitter's browser window upon completion of the business performance data file upload.

As discussed above, in various exemplary embodiments, the business performance data sharing computer system will require time to convert the data from the submitter-defined format illustrated by example in FIG. 5, to the standardized format. In various exemplary embodiments, a human operator will assist in at least a portion of the data conversion process. Furthermore, various financial data analysis operations will be performed on the business performance data in conjunction with converting the data to the standardized format so that one or more financial metrics may be calculated based on the business performance data. As stated in the message 600 of FIG. 6, once the conversion and data analysis have been completed, a message will be sent, preferably as an email message, to the submitter notifying him that the data conversation and analysis have been completed. In various exemplary embodiments, the data conversion and analysis will be completed in an automated manner by the business performance data sharing computer system. However, in various other embodiments, a person may review the converted business performance information to confirm that successful conversion and analysis have been performed prior to notifying the submitter, or may actually assist in the data conversion and/or financial analysis processes. In a preferred embodiment, the email message sent to the submitter notifying him that the business performance information has been successfully converted will also contain a click through link, which, if selected, will return the submitter to the website associated with the business performance information sharing data center computer system. Once the submitter arrives at the data center computer system and goes through the secure login procedure, the submitter is able to view his converted business performance information.

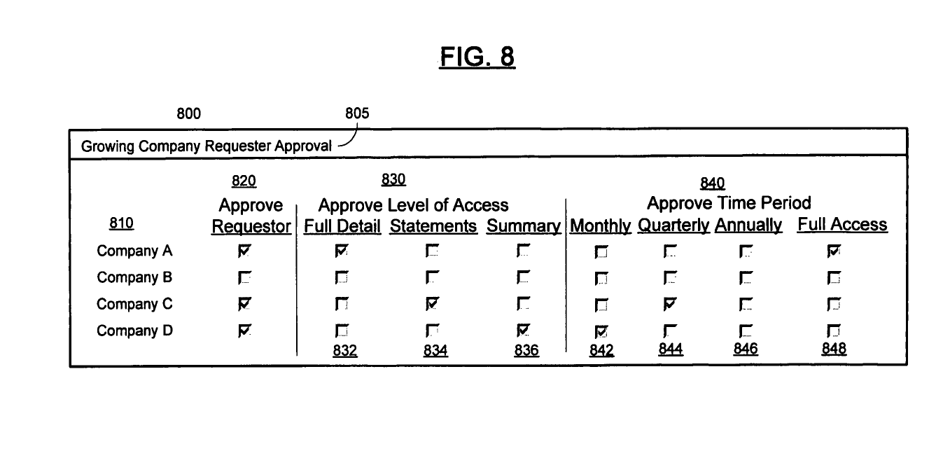

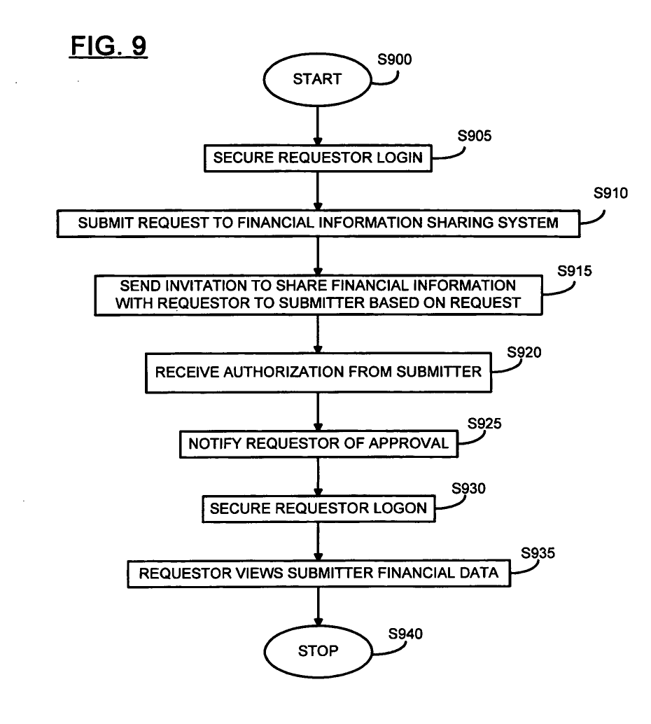

Referring now to FIG. 7, FIG. 7 is a graphic image of an interactive financial dashboard presenting business performance data of a submitter business in a combined text and graphic format generated by an network-based business performance information sharing system according to various exemplary embodiments of this invention. In various exemplary embodiments, the financial dashboard is one standardized format created by the conversion and analysis process of the business performance information sharing data center computer system according to this invention. However, it should be appreciated that the specific layout of the financial dashboard 700 shown in FIG. 7 is an exemplary data presentation only. In various exemplary embodiments, the dashboard 700 may be automatically loaded after the submitter has successfully logged in, or, alternatively, may be selected from a submitter specific home page having a plurality of different links including links such as “approve requestor,” “update submitter information,” “upload new performance information,” “view financial dashboard,” etc. As discussed above, once the submitter receives a confirmation message indicating that conversion and analysis of the business performance data have been completed, the submitter may then log back into the business performance data center computer system to view the analyzed, reformatted, and summarized data as the financial dashboard 700 shown in FIG. 7.

The financial dashboard 700 provides a summarized control point for viewing various aspects of the submitter's business performance data. For example, a financial metrics section 705 may be included in the dashboard 700 and lists various financial metrics including total revenue, gross profit, net income, gross margin percentage, net margin percentage (after tax), EBITDA, etc. Specific choice of financial metrics is not critical to the invention. Rather, any suitable financial metrics may be utilized. Additionally, all financial metrics need not appear on the dashboard. Rather, in the alternative, a link may be provided that allows the viewer to access a list of all financial metrics.

With continued reference to FIG. 7, for each financial metric 705, data is provided in tabular format which includes values for that metric for various time periods. For example, for each financial metric 705, a value is provided for Year-to-Date versus the same period YTD of the previous year, the current period versus the same period of the previous year, the trailing 12 months, etc. In various exemplary embodiments, it may be desirable to include more or less periods for each financial metric 705 included in the financial dashboard 700.

Another portion of the financial dashboard 700 displays company information 715 including any company comments 710 entered and uploaded by the submitter with the business performance data file as shown in FIG. 4. In various exemplary embodiments, the company information will include various identification and classification information for the submitter business including the fiscal year end for that business, the frequency of upload, the corporate structure of the submitter, submitter contact information and type (sector) of business that the submitter business is engaged in.

Also included in the financial dashboard view 700 shown in FIG. 7 is a chart section 720. As shown in the Figure, the chart is based on data taken from the total revenue metric. However, in a preferred embodiment, by selecting any one metric from the list of metrics 705, the chart will be updated to provide a graphical representation of the data for that metric as indicated on the financial dashboard 700.

As previously stated, the customized financial dashboard 700 serves as an interface for the submitter to his business performance information after information has been converted and analyzed by the data center computer system of the present invention. In various exemplary embodiments, by selecting a period pull down menu 725, the submitter can change the current period to a different period causing information fields in the financial dashboard 700 to be automatically updated. Also, the main user menu 730 may be accessed from the dashboard 700, permitting the submitter to view various levels of data, see the results of financial analysis, upload additional information. In various exemplary embodiments, the submitter will also be able to authorize third party/requestor viewing of business performance information from the financial dashboard 700. In various other exemplary embodiments, requestor viewing is authorized through another process not accessed through the financial dashboard 700. This other process may comprise a web form, an email message, facsimile, telephone conversation or other suitable authorization mechanism.

Referring now to FIG. 8, FIG. 8 is a graphic image illustrating a requestor approval window 800 provided to a submitter of business performance information to permit selective third party/requestor access to that submitter's business performance information in accordance with various exemplary embodiments of this invention. As discussed above, in various exemplary embodiments, the requestor approval window 800 will be accessed by a submitter of business performance information through the financial dashboard for that submitter. In various other exemplary embodiments, the submitter will access the requestor approval page through a separate electronic message sent directly to the submitter after data conversion and analysis has been performed.

In at least one embodiment, the third party companies listed in the requestor approval page 805 are defined by the submitter in response to the submitter's desire to share his business performance information with one or more companies. In this embodiment, the submitter may select companies from a list of companies participating in the business performance information sharing system of the present invention. Alternatively, the submitter may “write in” the name of one or more requestor companies who do not yet participate in the business performance information sharing system. In this instance, the requester company may be contacted, either automatically, or through other means, and informed that a submitter company would like to share their business performance information with the company and thus invited to subscribe to the business performance information sharing system. In at least one other embodiment, the company or companies listed in requestor approval page will be predefined based on companies that have made a request for business performance information of that submitter. In either of these embodiments, or any other embodiments, requestors/third parties are unable to view business performance information on any submitter without that submitter's prior express authorization.

With continued to reference to FIG. 8, the requestor approval window 800 includes a customized heading 805 including the name of the submitter's company and list of one or more requestor companies 810. As stated above, this list may be defined by the submitter from a list of companies participating in the business performance information sharing system, or, alternatively, may be predetermined based on requesters who have requested business performance information on the submitter. In either embodiment, for each requester 810 listed in the requestor approval window 800, the submitter must explicitly approve that requestor to view its business performance information. In various exemplary embodiments, and as shown in FIG. 8, requestor approval is accomplished by selecting a check box under an approval requestor heading 820. In various exemplary embodiments, the submitter will also specify, for each authorized requestor, a level of access to business performance information authorized for viewing. As shown in FIG. 8, under the heading “Approve Level of Access” 830, these levels of access may include a full detail level, a financial statement level, and a summary level of access. The summary level of access may consist of an agreed set of metrics between the submitter and requestor. In various exemplary embodiments, this is also accomplished through the use of check boxes labeled full detail 832, statement 834 and summary 836 respectively, under each of the various levels of access in the approve level of access section 830 of the requester approval window 800. It should be noted that for ease of illustration only, three levels of access are shown in FIG. 8. However, for various reasons, it may be desirable to utilize more or less levels of access. Also shown in FIG. 8 is an Approve Time Period section 840 which allows the submitter to specify, for each approved requester, a time period of performance information that may be accessed. For example, and as shown in FIG. 8, these periods may include monthly, quarterly, annually, or full access meaning all available time periods or whenever new information is uploaded to the system. In various exemplary embodiments, this too is accomplished through the use of checkboxes 842, 844, 846 and 848 listed under each time period for each requestor company. Though not shown in FIG. 8, the requestor approval screen 800 may also include fields permitting the submitter to specify, for each approved requestor/receiver, a frequency with which business performance information should be updated for that requestor/third party.

FIGS. 1-8, as described above, detail the experience of the submitter business in interacting with the system for sharing business performance information according to various embodiments of this invention. The specification and drawing figures will now describe embodiments of the present invention in the context of requestor's interaction with the business performance information sharing data center computer system. Though it should be appreciated that these figures and discussion are exemplary only and should not be interpreted as a limiting the invention to the specific embodiments and examples illustrated and discussed herein. Referring now to FIG. 9, FIG. 9 is a flow chart illustrating the steps of a method for requesting and receiving business performance information from a submitter business through the selective business performance sharing information system according to this invention. The method begins in step S900 and proceeds to step S905 where the requestor logs in to the business performance information data center computer system through a secure login screen in a manner analogous to that described in the context of FIG. 3. In a preferred embodiment, if the requestor is not yet a participant in the business performance information sharing network, the requestor will be prompted to join the network. In various exemplary embodiments, this will be accomplished by registering through an online electronic registration system. Once the requestor has logged in, operation of the method proceeds to step S910, where the requestor submits a request, through his web browser interface to the business performance information data center computer system to view business performance information of at least one submitter business. The submitter business may be chosen from a list of participating submitter businesses or, alternatively, the requestor may “write in” the name of a submitter business. In this case, the submitter business will be notified of the requestor's desire to view its business performance information and invited to participate in the business performance information sharing system. Based on this request, in step S915, the business performance information data center computer system will send a message to the submitter alerting the submitter to the fact that a currently unapproved requestor would like to view his business performance information. In a preferred embodiment, this message will include a click through link to enable the submitter to be automatically directed to business performance information sharing data center computer system so that the submitter can approve the requestor in a manner analogous to that discussed in the context of FIG. 8.

If, based on the invitation sent in step S915, the submitter approves the request, then, in step S920, submitter authorization is received. In various exemplary embodiments, if the submitter does not approve the request, the system will send a messaging indicating this to the requestor. Operation of the method then proceeds to step S925 where the business performance information sharing data center computer system sends a message to the requestor notifying him that he has been approved to view the submitter's business performance information. As discussed above, in various exemplary embodiments, this notification message will preferably include a click through link to automatically direct the requestor to the business performance information sharing data center computer system. When the requestor returns to the business performance information sharing data center computer system, operation of the method proceeds to step S930, where the requestor must again perform a secure login to authenticate his identity. Once the identity of the requestor has been confirmed, operation continues to step S935 where the requestor may view the business performance information of the submitter in a manner that will be discussed in greater detail below. In various exemplary embodiments, the requester will view business performance information in a manner analogous to that illustrated and discussed in the context of FIG. 7. Operation of the method ends in step S940.

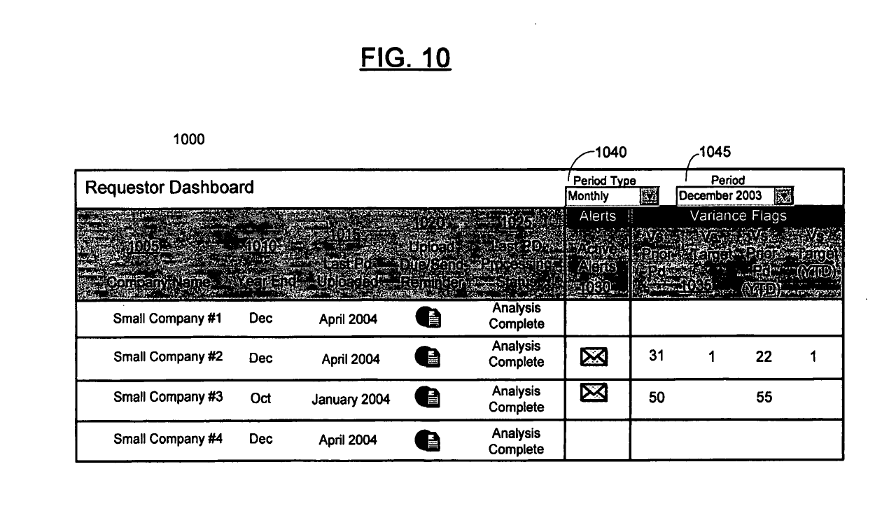

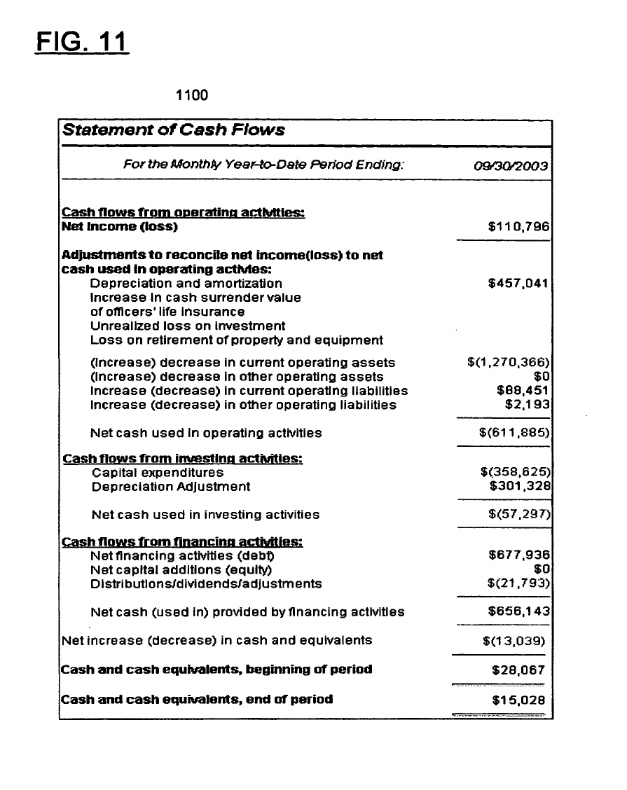

Referring now to FIG. 10, FIG. 10 is a screen capture of a requester dashboard 1000 as viewed by a requester upon logging on to the business performance information sharing data center computer system in accordance with various exemplary embodiments of this invention. It should be appreciated that layout of the requestor dashboard 1000 is exemplary only. The dashboard may take a variety of different forms and be comprised of multiple levels of information without departing from the spirit or scope of this invention. For purposes of example only, the requestor dashboard 1000 of FIG. 10 is shown containing information on four companies, small company #1 through small company #4. However, it should be appreciated that the view shown in FIG. 10 assumes that the requestor has already been approved to view business performance information of one or more submitter business. When a requester logs into the business performance data center computer system for the first time after subscribing, he may not have any submitter companies listed in his requester dashboard.

With continued reference to FIG. 10, the interactive requestor dashboard serves as the summary page for each requester, listing each submitter business authorizing that requester company to view its business performance information. In various exemplary embodiments, the requestor dashboard will include, for each authorizing submitter, various data fields summarizing information about the submitter. For example, in FIG. 10, for each submitter company listed under the company name heading 1005, a fiscal year end field 1010, a last period uploaded field 1015, an upload due/send reminder link 1020 and a last period processing status field 1025 are included. In a preferred embodiment, clicking on the upload due/send reminder link 1020 will automatically send a message to the contact person for that submitter identifying the requestor and reminding the submitter to upload current business performance data. Alternatively, clicking on the upload due/send reminder link 1020 will invoke a blank email message window that is pre-addressed to the submitter and that is configured to permit the requestor to write a customized message to the submitter to remind him to upload his current business performance information. Alternatively still, the system will automatically send reminders to the submitter when an upload of financial information is due for a particular authorized requestor/receiver in accordance. In any of these embodiments, it is preferable that the message include a click through link to permit the submitter to be automatically routed to the business performance information sharing data center computer system to facilitate the upload of current business performance information.

In various exemplary embodiments, the portion of the requestor dashboard 1000 containing the company name section 1005, the fiscal year end section 1010, the last period uploaded section 1015, the upload due/send reminder section 1020 and the last period processing status section 1025 is substantially static to the extent that it only changes if new submitter information is received or if submitters are added or removed from the list. However, in various exemplary embodiments, the requestor dashboard 1000 also includes a dynamic portion including an alerts section 1030 and a variance flags section 1035. In these exemplary embodiments, the alerts section allows the requestor to set up alerts to be automatically executed if one or more events occur in connection with a submitter's performance information. These events may be based on timing and/or one or more financial metrics associated with that submitter either exceeding or declining versus a pre-defined threshold. In FIG. 10, the active alerts in the alerts section 1030 are represented as linked envelopes. In various exemplary embodiments, the requester will click on the envelope to view the actual alert in a separate window. Alternatively, clicking on the individual alert link will cause the actual alert message to be electronically mailed to the requester.

One or more variance flags may also be defined by the requestor to cause flags to be automatically generated upon the occurrence of one or more events in the business performance data for that submitter. For example, in the variance flag section 1035 of the requestor dashboard 1000, flags may be set, accumulated and compared against the previous business performance period, against targets, against the previous business performance period cumulatively through the year, and against targets cumulatively throughout the year. In order to the change the business performance period for the dynamic section of the requestor dashboard 1000, including the alerts section 1030 and the variance flag section 1035, the user may select a different control value from the period type 1040 and period 1045 pull down menus. In various exemplary embodiments, the period type pull down menu 1040 will include a plurality of different business performance periods such as, for example, weekly, monthly, quarterly, annually, rolling twelve months, since inception, etc. Furthermore, in various exemplary embodiments, selecting a value from the period type pull down menu 1040 will change the available periods from the period pull down menu 1045. For example, if monthly is selected by the requestor from the period type pull down menu 1040, then only the available months will be listed in the period pull down menu 1045. Alternatively, if quarterly is selected by the requestor from the period type pull down menu 1040, then only the available quarters will be listed in the period pull down menu 1045.

With continued reference to FIG. 10, in various exemplary embodiments, each submitter company listed company name section 1005 of the requestor dashboard 1000 will be represented as a text hyperlink. By clicking on the text hyperlink of a particular submitter business, the requestor will be taken to the financial dashboard for that submitter business and presented with a screen that is substantially the same as that seen by the submitter and represented graphically in FIG. 7. Through a tool bar, such as the tool bar 730 shown at the top of the dashboard in FIG. 7, and depending upon the level of access granted to the requestor by that submitter, the requestor may view various portions of the submitter's business performance data including alerts and variances, analysis and reports. Though not shown on the requestor dashboard 1000 of FIG. 10, next to each submitter's name in the company name section 1005, there may also be an indication of the level of access granted to the requestor by the submitter from the plurality of different levels of access and/or an indication of time period approved and/or frequency of information updates for that requestor.

FIGS. 11, 12 and 13 illustrate various exemplary business performance data presentations viewable by a requestor through the submitter's financial dashboard depending upon the level of access granted to the requestor by the submitter. FIG. 11 is a Statement of Cash Flows 1100 taken from the analysis tab of the financial dashboard for the submitter and is exemplary of business performance information associated with a statement level of access. During the data conversion and analysis step, the business performance data center computer system analyzes the submitter defined data to create one or more tables organized in accordance with generally accepted accounting principles (GAAP). By creating standardized views that are in accordance with GAAP, requesters of business performance information may make educated decisions regarding the business performance and operating condition of other business entities and may easily compare two or more similarly situated businesses without having to first standardize each businesses data. Also, by data standardization, requestors may monitor the performance of a submitter using financial metrics that the requestor is familiar with.

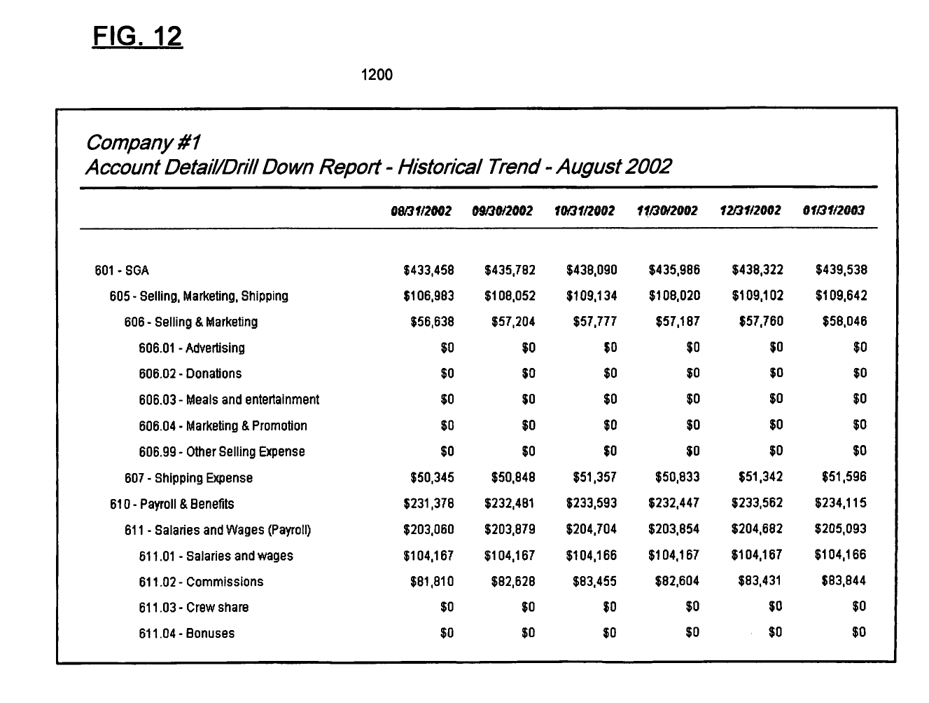

FIG. 12 is a graphic image of an exemplary account detail/drill down report containing business performance data of a submitter business as viewed by a requestor in accordance with various embodiments of this invention. The drill down report 1200 shown in FIG. 12 is exemplary of business performance information associated with a full detail level of access. The particular report illustrated in FIG. 12 is based on a Selling, General & Administrative (SG&A) account and shows the aggregate and component individual account entries in a historical trend perspective over a business performance reporting period of the trailing 12 months. It should be noted that although data for a trailing 12 month period are shown in FIG. 12, the report may be less then six months, for example one quarter, or longer then six months, for example one year. As discussed above, a requestor's ability to view this level of information is determined by the submitter in accordance with the procedure outlined in the discussion of FIG. 8 above. Typically, for a requester to view such an entry level report, the requestor would have to have been granted a full detail level of access.

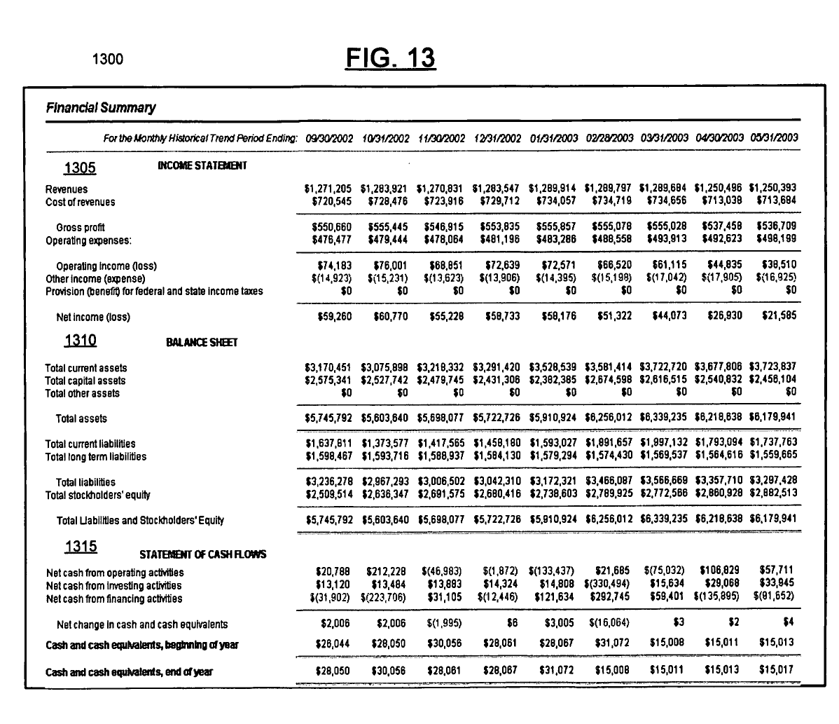

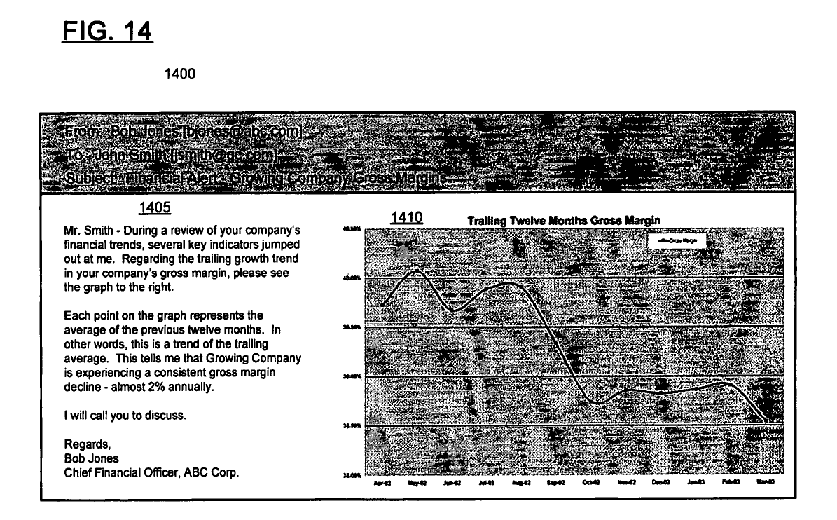

FIG. 13 is a graphic image of a financial summary table 1300 created by the business performance information sharing data center computer system in accordance with various exemplary embodiments of this invention. The table 1300 is representative of business performance information that would be viewed by a requestor authorized to view summary level data only. The table 1300, as shown in FIG. 13, includes various summary level financial statements including an income statement 1305, a balance sheet 1310, and a statement of cash flows 1315. It should be appreciated that the summary level financial statements shown in FIG. 13 are for purposes of example only. As discussed above, the actual statements chosen may be selected from a list of well known financial metrics and customized depending upon the desires of the submitter and the requester. Furthermore, the individual account entries provided under each financial statement are illustrative only. More or fewer individual account entries may be utilized without departing from the spirit or scope of this invention. As stated above, the financial summary report shown in FIG. 13, is comprised of an income statement portion 1305, a balance sheet portion 1310 and a statement of cash flows section 1315. For each individual account entry in each portion, there is entry for each month of the total reporting period. FIG. 13, shows a reporting period ranging from Sep. 30, 2002 to May 31, 2003. In various exemplary embodiments, the financial periods appearing in the financial summary report will be dictated by the time period approved by the submitter as discussed above in the context of FIG. 8. In various exemplary embodiments, when viewing the submitter's business performance information, the requestor will be able to reduce or expand the time period for which data is shown in the financial summary report 1300 from within the set of available time periods authorized for that requestor. For example, the requestor could view data for an entire 12 month period, or alternatively, isolate data for an individual quarter.

Referring now to FIG. 14, FIG. 14 illustrates an exemplary message 1400 from a requester to a submitter, generated by the business performance information sharing data center computer system in accordance with embodiments of this invention. A useful feature of the business performance data sharing computer system according to this invention is that while viewing business performance data of a submitter, a requestor may automatically incorporate various portions of the data into an email message, such as a message to the submitter or to another member of the requestor's organization. For example, while a submitter is logged in to the data center computer system, the submitter may send a message to a requestor by selecting a messaging link. In a preferred embodiment, a list of participating requesters will be displayed to the submitter including an email address associated with the requester. Alternatively, requestors may communicate with submitters who have authorized them to view their business performance information or with other members of the requestors organization through the system of the present invention. However, in a preferred embodiment, person to person messages may only be sent through the system to participating members in order to protect the privacy of submitter business performance information.

In the example shown in FIG. 14, a requestor is sending a message to a submitter regarding a component of that submitter's business performance information. The message includes a customized text portion 1405 and a graph 1410 illustrating the trailing twelve months gross margin for that submitter. By use of this feature, a requester can pull specific portions out of the business performance information of a submitter and initiate a discussion about the selected portions without either party having to refer back to the information stored in the business performance information sharing data center computer system. The ability of submitters and requesters to be able to interact with one another without exiting the system is a useful feature of this invention.

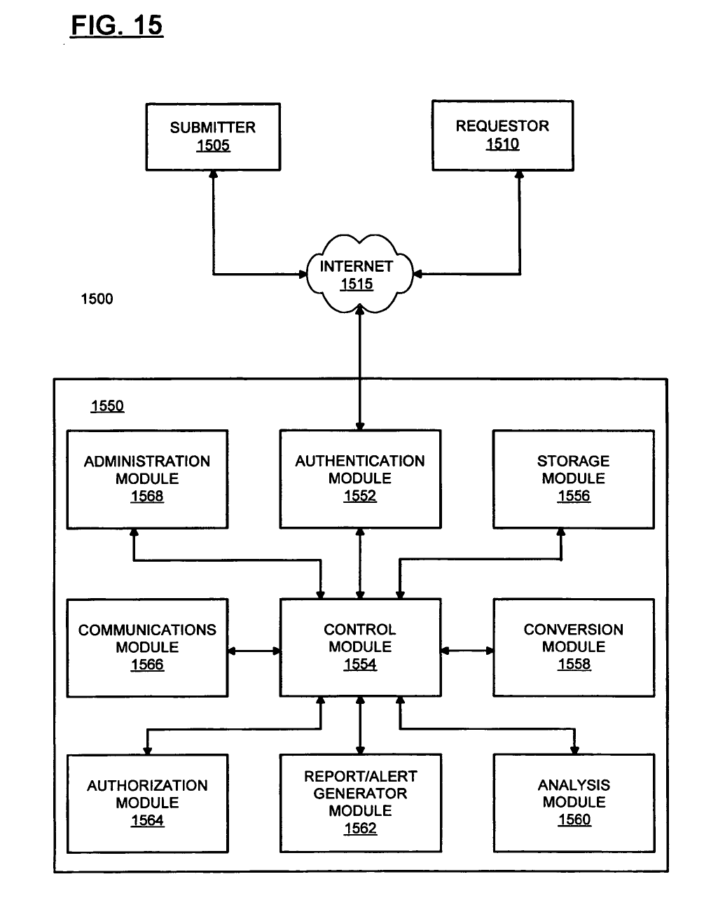

Referring now to FIG. 15, FIG. 15 is a block diagram illustrating a business performance information sharing network 1500 including a business performance information sharing data center computer system 1550 connected to a submitter computer system 1505 and a requestor computer system 1510 via the Internet 1515. In various exemplary embodiments, and as illustrated in FIG. 15, the business performance information data center computer system 1550 will comprise several task specific modules. Each module may consist of a circuit, route or application or a subroutine of an overall software program, or multiple software programs in communication with one another. The modules shown in the FIG. 15 include an authentication module 1552, a control module 1554, a storage module 1556, a conversation module 1558, an analysis module 1560, a report/alert generator module 1562, an authorization module 1564, a communications module 1566 and an administration module 1568. However, it should be appreciated that the modules should not be taken to imply required structure, but rather as an exemplary embodiment to facilitate system functionality. In various exemplary embodiments, the control module 1554 will be implemented as a microprocessor. However, the control module 1554 may also be implemented as single purpose computer system, a multipurpose computer system, and application specific integrated circuit (ASIC), a microcontroller, or other type control circuit. Moreover, the storage module 1556 may be implemented as a computer hard disk, electronic memory, a combination of electronic memory and a computer hard disk, optical storage, or other suitable storage medium. In various exemplary embodiments, the administration module 1568 will not directly provide functionality to submitters or requestors, but rather will be used by administrators of the business performance information sharing data center computer system to troubleshoot the system, to upgrade software components, to perform data backup operations, and to perform other administrative operations associated with maintaining the data center computer system 1550.

With continued reference to FIG. 15, submitters 1505 and requesters 1510 access the business performance information sharing data center computer system 1550 through an authentication module 1552. In various exemplary embodiments, the authentication module 1552 will authenticate identification information entered through a secure web page. The authentication module 1552, under the control of the control module 1554 will compare the entered information against previously registered information for that submitter or requester to prevent authorized access to business performance information.

Discussion of the business performance information sharing data center computer system will now proceed in the context of submitter functions. Once a submitter has been authenticated, the control module 1554 will send a page from the storage module 1556 including instructions to prompt the user to upload his business performance information to the data center computer system 1550. In various exemplary embodiments, this process will comprise sending a web page from the storage module 1556 to the submitter 1505 via the Internet 1515 containing a link to upload a business performance information file. Once the uploaded file has been received, several functions are performed under the instruction of the control module 1554. Firstly, in various exemplary embodiments, the control module 1554 causes the uploaded business performance data file to be stored in the storage module 1556. In various exemplary embodiments, the control module 1554 will also cause the communications module 1564 to send a message to the submitter notifying him that data was successfully uploaded. Then, the control module 1554 will invoke the conversion module 1558 and the analysis module 1560. The conversion module 1558 will reformat the stored business performance data from the user defined format to a standardized format as discussed herein.

The analysis module 1560 will perform various data analysis operations on the stored business performance data including evaluating the data in accordance with generally accepted business performance metrics. As noted above, the business performance information may have a user-defined format particular to the preferences of the business supplying the information, whereas the performance analysis techniques applied to the business performance information may be ineffective of inaccurate unless the business performance information to be analyzed is compiled in a standard format. Accordingly, the business performance information file may be provided to the conversion module 1558 for conversion to a standard format.

In at least one embodiment, the conversion module 1558 utilizes a conversion mapping process associated with the business to convert the format of the business performance information to a standard format based on the information entered by the submitter describing the format of the business performance information file. This conversion mapping process preferably implements a map or other data structure which represents a correlation between a submitter-defined business performance classification (e.g., a submitter-defined business performance account or operation classification) of the business performance information in its original format and a corresponding business performance classification (e.g., standard business performance account or operation classification) of the standard format. Thus, when converting the business performance information from the submitter-defined format to the standard format, the conversion module 1558 may use the conversion map to associate the values of the submitter-defined business performance classifications with the corresponding standard business performance classifications. In various exemplary embodiments, this mapping is done in accordance with information provided by the submitter. However, in various other exemplary embodiments, particularly when the submitter is submitting business performance information in response to a request from a business interested in viewing the business performance information of the submitter, the mapping may be done in accordance with information provided by the requestor.

In at least one embodiment, the analysis module 1560 is used to analyze business performance information from a variety of submitter businesses and therefore receives business performance information in a variety of particular formats. Accordingly, the conversion module 1558 may have access to a map database used to store conversion maps for a number of businesses. To map the business performance information for a particular business, the conversion module 1558 may obtain the conversion map associated with the business from the map database and use the conversion map to convert the business performance information.

The conversion map associated with the business may be implemented in a variety of forms. For example, the conversion map may be implemented in a data file as a table or other pairing of an identifier of a user-defined performance classification with the identifier of the corresponding standard performance classification which is stored either in the storage module 1556 or in the conversion module 1558 directly. As an example, the business may have assigned account number 110-01 to the “truck depreciation” account and account number 110-02 to the “other assets depreciation” account, whereas the “asset depreciation” account of the standard format is assigned an account number of, for example, 125.05. Therefore, the conversion map in this example may include a pair listing of (110-01, 125.05) and (110-02, 125.05), thus indicating to the conversion module 1558 that the values associated with the user-defined accounts identified by account numbers 110-01 and 110-02 should be associated with the standard account identified by account number 125.5. Alternately, links between user-defined business performance classification identifiers and standard business performance classification identifiers may be used to create executable software programmed to specifically convert performance information from the particular format to the standard format, where the executable software represents the conversion map. To illustrate, the conversion map associated with a business may be implemented as, for example, a software plug-in executed by the conversion module 1558. Accordingly, the conversion module 1558 may select and execute the appropriate software plug-in to convert business performance information having a submitter-defined format associated with the software plug-in to the standard format.

After conversion by the conversion module 1558, the control module 1554 causes the converted business performance information to be stored in the storage module 1556. Then, the control module 1554 invokes the analysis module 1560 to analyze the converted business performance data. The analysis module 1560 may be adapted to perform any of a variety of performance analysis techniques, including, for example, identification, evaluation and computation of performance metrics, trend analysis of performance metrics, benchmarking of performance metrics based on comparisons to peer businesses, and the like. The analysis module 1560 further may include one or more portfolio-based scenario analyses run on the aggregated standardized business performance information from one or more businesses, an entire industry, and the like. For example, the converted business performance information may be used to predict the future performance of a business or industry in the event that interest rates decline.

After the analysis module 1560 has completed the data analysis, the control module 1554 causes the analysis results to be stored in the storage module 1556 in association with that submitter's business performance information. Then, the control module 1554 invokes the report/alert generator module 1562 which generates at least one performance report based at least in part on the results generated by the analysis module 1560. The performance report may include a variety of information related to the business performance and/or operational performance of the business, such as, for example, a summary of key business performance and operational metrics (e.g., total revenue, net income, the debt-to-equity ratio, goods sold per store, etc.), tables or charts detailing the historical performance of performance metrics, a comparison of various performance metrics with performance metrics with one or more previous periods or cycles, benchmark comparisons of various performance metrics to the corresponding performance metrics of peer businesses or an industry standard, and the like.

The performance report further may include one or more alert indicators associated with certain performance report items, where the alert indicators are intended to cause a reviewer of the performance report to analyze the corresponding performance report items in greater detail. The alert indicator may be used to identify those performance report items that reflect positively on the performance of the business, as well as those performance report items that reflect negatively on business performance. In at least one embodiment, an alert indicator may be used when a change in the performance metric from a previous period exceeds a certain threshold or when the performance metric varies from a predetermined value by a certain threshold, where the predetermined value may represent an industry standard value or a target value prescribed by, for example, the business or a lender as part of a loan agreement with the business.

With continued reference to FIG. 15, after the control module 1554 determines that the report/alert generator module 1562 has finished processing, the control module 1554 causes the results to be stored in the storage module in association with that submitter's business performance data. Then, the control module 1554 causes the communications module 1566 to send a message to the submitter indicating that all data processing and analysis has been completed. When the submitter 1505 logs back into the business performance information sharing data center computer system 1550 through the authentication module 1552, the control module 1554 sends a signal to the storage module 1556 to load the converted and analyzed business performance data for presentation to the submitter. In response to the submitter selecting a link to authorize third party viewers, the control module 1554 causes the authorization module 1564 to load a screen prompting the submitter to authorize one or more third party requestors to view that submitter's business performance data. As discussed above, in various exemplary embodiments, this list may be predetermined based on a list of requester businesses who have requested performance information on that submitter, or submitter may be prompted to select a requestor from a list of participating requesters. In yet another embodiment, the submitter may “write in” the name of one or more requesters not currently participating. This information may be used by the administrators of the business performance information sharing system to invite potential requestors to subscribe to the system. The results of this authorization are stored in the storage module 1556. In various exemplary embodiments, the control module 1554 will also cause the communications module 1566 to send a message to the submitter confirming the selection of authorized third party requestors.

Discussion of the business performance information sharing data center computer system will now proceed in the context of requestor functions. A requester 1510 accessing the business performance information sharing data center computer system 1550 via the Internet 1515 must first login through the authentication module 1552. As with submitter login, the authentication module 1552 will compare identification information of the requestor 1556 with stored identification for that requestor 1510. If, the authentication module determines that the requestor's credentials are authentic, then the control module 1554 will cause the storage module 1556 to load a web page, such as a requestor dashboard, for that requester. As noted above, the requestor dashboard may contain businesses chosen by the requestor, submitter businesses that want to share their performance information with the requestor business, or both. By selecting a submitter from the list of companies included in the requestor dashboard, the control module 1554 will cause the storage module 1556 to load the financial dashboard containing business performance information of that submitter. If the user selects alerts from the business performance dashboard the controller will cause the report/alert generator module 1562 to load an interactive web page allowing the requestor to customize alert options and report options. The results of this customization will be stored in the storage module 1556.

In various exemplary embodiments a requestor may submit a request to the business performance information sharing data center computer system 1550 requesting business performance information on one or more submitter businesses. In this embodiment, once such a request is received by the data center computer system 1550, the control module 1554 will search the storage module 1556 for the submitter. If a set of business performance information associated with that submitter is found, the control module 1554 will issue a command invoking the communications module 1566 to send a message over the Internet 1515 to the submitter notifying the submitter that the requestor is interested in viewing the submitter's business performance information and inviting the submitter to authorize the requestor. In various exemplary embodiments, the message will specifically identify the requestor. In various exemplary embodiments, identifying the requestor may include identifying the requestor company by name, identifying an individual associated with the requestor company, such as by way of example an employee, representative or agent, or both. In order to approve the requester, the submitter will login to the data center computer system 1550. After being authenticated by the authentication module 1552, the control module 1554 will cause the authorization module 1562 to prompt the requestor to authorize the requestor. After authorization has been received by the authorization module 1562, the control module 1554 will cause the communications module to send a message to the requestor notifying him that he has been authorized to view business performance information of the submitter. Interaction with the business performance information sharing data center computer system 1550 will then proceed in the manner discussed above.

In addition to the submitter and requester experiences described above, a situation may arise where a requestor would like to obtain performance information on the submitter at a higher level than currently authorized for. This may be facilitated through one of several procedures. In one exemplary embodiment, the requester may, while securely logged in to the data center computer system 1550, invoke the communications module 1566 to create a message addressed to the submitter by selecting a contact submitter link from the requestor's dashboard or elsewhere located within the requestor's data presentation. In a preferred embodiment, this message will include a click through link to allow the submitter to return to the data center computer system 1550 and, after having been authenticated by the authentication module 1552, to automatically invoke the authorization module 1564 to allow the submitter to change the approved level of performance information access for that requestor. Any changes made to the access information will overwrite the existing access information stored in the storage module 1556. It should be noted that at any point, the submitter can change the level of access for a given requestor or add and remove requesters by returning the to data center computer system 1550, authenticating, and invoking the authorization module 1564.

In addition the various submitter and requestor functions discussed above, submitters and requestors may utilize the various modules of the data center computer system 1550 to perform a variety of administrative functions through automated alerts and messages. For example, on the submitter side, if the submitter has authorized a requestor for monthly information updates, the submitter sets the data center computer system 1550 to send an automated reminder message to the submitter prior to the end of each month. In this case, the control module 1554 will periodically interrogate storage module 1556 for the expiration of such time driven events. If, the controller determines that the time specified for the time driven event has expired, the controller will invoke the communications module 1566 to send a message to the submitter reminding him to upload his financial information. As discussed herein, this message will preferably include a link to return the submitter to the data center computer system 1550.

From the requestor side, the requestor may instruct the data center computer system 1550 to perform various automated messaging functions. For example, for a given submitter who has approved the requester, the requestor may request that he be automatically notified by the system 1550 whenever an authorizing submitter has uploaded new performance information. In such a case, once the data upload is received, the control module 1554 will check the storage module 1556 for any such stored conditions. If such a condition is found, the control module 1554 will invoke the communications module 1566 to send a message to the requester notifying him of the data update. A requestor may program to the data center computer system 1550 to perform various performance information monitoring functions. For example, an authorized requester of business performance information may desire to have the data center computer system 1550 monitor the business performance information of authorizing submitters in accordance with one or more financial metrics, and to program threshold alerts which cause an automated message to be sent to the requester if the value of the one or more metrics falls below or above a threshold amount. In this embodiment, alert thresholds will be stored in the storage module 1556. Periodically, or upon data uploads, the control module 1554 will interrogate the performance data of authorizing submitters for each requestor to determine compliance with any alert thresholds. If, the control module 1554 determines that any of the metrics has exceeded any alert thresholds, the control module 1554 will invoke the communications module 1566 to send a message in accordance with that submitter's previously stored instructions. Through the use of these automated messaging functions, submitters and requestors may rely on the data center computer system 1550 to perform several event driven and analytical operations enhancing the value of the system to the paticipants.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

1. A method for selectively sharing business performance information of a submitter business with one or more requester businesses, comprising the steps of:
generating at least one business performance report based on data associated with a submitter business on a computer system;
uploading the at least one business performance report to a data center computer system via a communications network;
converting, using an automated process executed by said data center computer system, said as least one business performance report from a first data format to a second data format; and
receiving an instruction from said submitter business, said instruction including an indication of at least one receiver business authorized to view said at least one business performance report associated with said submitter business in said second format over said communications network.

2. The method of claim 1, the step of generating at least one business performance report comprising generating at least one business performance report using an accounting software program running on the computer system and saving the report as at least one electronic file.

3. The method of claim 2, wherein the step of generating at least one business performance report comprises generating a report based on data from a business performance period.

4. The method of claim 2, wherein the step of generating at least one business performance report comprises generating a trial balance report.

5. The method of claim 1, the step of uploading said at least one business performance report comprising logging into an Internet website associated with the data center computer system through a secure connection and uploading at least one electronic file to the data center computer system.

6. The method of claim 1, the step of converting said at least one business performance report from a first format to a second format comprising converting said at least one business performance report from a submitter-defined format to a standardized format.

7. The method of claim 6, the step of converting said at least one business performance report further comprises analyzing said business performance data in accordance with at least one financial metric.

8. The method of claim 7, wherein said at least one financial metric is chosen from the group consisting of revenue growth, gross margins, EBIT and EBITDA margins, cash position and cash flow generation, debt to total capitalization ratio, funded debt to EBITDA ratio, interest coverage metrics, and other generally accepted accounting metrics.

9. The method of claim 7, the step of converting said at least one business performance report further comprises generating one or more alerts in said second format if said at least one financial metric is below a predetermined threshold set by a requesting party for each of said metrics.

10. The method of claim 1, the step of receiving an instruction from said submitter business further comprising receiving an instruction indicating a level from a plurality of levels of business performance information that a may be accessed by receiver business.

11. The method of claim 1, the step of receiving an instruction from said submitter business further comprising receiving a instruction indicating a time period of performance information for which the requestor business is authorized to view.

12. The method of claim 10, further comprising the step of displaying said business performance report to said authorized receiver business in said second format based on said indicated level of business performance information authorized for that receiver business.

13. The method of claim 11, further comprising the step of displaying said business performance report to said authorized receiver business in said second format based on said indicated time period of performance information authorized for that receiver business.

14. A method for sharing business performance data of a submitter business with one or more requester businesses comprising:
generating, with a software program executing on a computer system, at least one business performance report comprising business performance data of a submitter business in a first data format;
using a graphical user interface, uploading said at least one report to a data center computer system via the Internet;
converting, using an automated process executed by said data center computer system, said at least one report from said first data format into a second data format; and
receiving an indication from said submitter business, through said graphical user interface, of at least one receiver business authorized to view said at least one report in said second data format over the Internet.

15. The method according to claim 14, the step of generating at least one business performance report comprising generating a trial balance report.

16. The method according to claim 14, the step of generating at least one business performance report comprising saving the report as an electronic file.

17. The method according to claim 16, the step of uploading said at least one report comprising uploading the electronic file.

18. The method according to claim 14, using a graphical user interface comprising using a web browser software application.

19. The method according to claim 14, the step of converting the at least one report from said first data format into a second data format comprising converting the report from a submitter-defined format to a standardized format.

20. The method according to claim 19, the step of converting said at least one report from the submitter-defined format to a standardized format comprising performing a mapping from the specific submitter-defined format to the standardized format using a predetermined mapping function associated with the submitter-defined format.

21. The method according to claim 14, the step of converting further comprising analyzing said business performance data in accordance with at least one financial metric.

22. The method of claim 21, wherein said at least one financial metric is chosen from the group consisting of revenue growth, gross margins, EBIT and EBITDA margins, cash position and cash flow generation, debt to total capitalization ratio, funded debt to EBITDA ratio, interest coverage metrics, and other generally accepted accounting metrics.

23. The method of claim 21, the step of converting said at least one business performance report further comprises generating one or more alerts in said second format if said at least one financial metric is below a predetermined threshold set by a requesting party for each of said metrics.

24. The method of claim 14, the step of receiving an instruction from said submitter business further comprising receiving an instruction indicating a level from a plurality of levels of business performance information that a may be accessed by the receiver business.

25. The method of claim 14, the step of receiving an instruction from said submitter business further comprising receiving a instruction indicating a time period of performance information for which the receiver business is authorized to view.

26. The method of claim 24, further comprising the step of displaying said business performance report to said authorized receiver business in said second format based on said indicated level of business performance information authorized for that receiver business.

27. The method of claim 25, further comprising the step of displaying said business performance report to said authorized receiver business in said second format based on said indicated time period of performance information authorized for that receiver business.

28. A system for automated submitter controlled sharing of business performance information between a submitter business and one or more requestor businesses comprising:
at least one data center computer system configured to:
operate at least one Internet web site displaying one or more Internet web pages;
receive business performance information associated with a submitter business via data upload of at least one business performance information file from said submitter business over the Internet, said at least one business performance information file formatted in a first data format;
using software instructions executing on said data center computer system, converting said at least one business performance report into a second data format;
receive an indication from said submitter business of at least one requestor business authorized to view said at least one business performance report;
notify said requestor business that they have been authorized by the submitter business; and
display said at least one business performance report to said at least one requester in said second data format over the Internet based on said indication.

29. The system of claim 28, wherein said at least one business performance information file comprises a trial balance report stored as an electronic file.

30. The system of claim 28, wherein said indication comprises responses selected by the submitter on an interactive web page indicating, for each authorized requestor business, a level of business performance information that may be viewed from the total set of available business performance information.

31. The system of claim 28, wherein said indication comprises responses selected by the submitter on an interactive web page, indicating, for each authorized requestor business, a period of business performance information that may be viewed from all the periods of available business performance information.

32. The system of claim 30, wherein said data center computer system is configured to display said at least one business performance report to said at least one requestor based on said indicated level of business performance information authorized for each requester.

33. The system of claim 31, wherein said data center computer system is configured to display said at least one business performance report to said at least one requester based on said indicated period of business performance information level of business performance information authorized for each requester.

34. The system of claim 32, wherein said data upload comprises an interactive data file upload web page including one or more submitter-defined fields used to characterize said data file.

35. The system of claim 32, wherein said data center computer system is configured to convert said at least one business performance report from a submitter-defined format to a standardized format.

36. The system of claim 35, wherein said data center computer system is configured to convert said at least one business performance report from a submitter -defined format to a standardized format using a predetermined mapping function associated with the submitter-defined format band based on values of the one or more submitter-defined fields.

37. The system of claim 28, wherein the data center computer system is configured to analyze the business performance data in accordance with at least one financial metric.

38. The system of claim 28, wherein said at least one financial metric is chosen from the group consisting of revenue growth, gross margins, EBIT and EBITDA margins, cash position and cash flow generation, debt to total capitalization ratio, funded debt to EBITDA ratio, interest coverage metrics, and other generally accepted accounting metrics.

39. The method of claim 37, wherein the data center computer system is configured to generate one or more alerts in said second format if said at least one financial metric is below a predetermined threshold set by a requesting party for each of said metrics.

40. In an environment comprising a plurality of submitter businesses, each submitter business associated with at least one submitter business computer system, a data center computer system, and a plurality of requester businesses, each requestor business associated with at least one requestor computer system, said submitter business computer systems and said requester business computer systems connected to said data center computer system via a communications network, a system for selectively sharing business performance information of a submitter business with a requestor business, the system comprising:
at least one data center computer system comprising:
means for electronically receiving over a communications network at least one business performance information file associated with a submitter business, said at least one business performance information file in a first data format;
automated means for converting said at least one business performance information file into a second data format;
means for receiving an indication from said submitter business of at least one requestor business authorized to view said information;
means for notifying said requestor business that they have been authorized by the submitter business; and
means for displaying information contained in said at least one business performance information file to said authorized requestor in said second data format over said communications network.

41. The system of claim 40, means for electronically receiving at least one business performance information file comprises means for presenting to a user an interactive file upload web page to a web browser of the submitter to facilitate transfer of the at least one business performance information file to the data center computer system.

42. The system to claim 40, wherein said at least one business performance information file comprises a trial balance worksheet saved as an electronic file.

43. The system of claim 40, wherein automated means for converting said at least one business performance file into a second data format comprises means for converting the report from a submitter-defined format to a standardized format.

44. The system of claim 43, wherein said means for converting the report from a submitter-defined format to a standardized format comprises a software-based mapping function for converting the data file from the specific submitter-defined format to the standardized format using a predetermined mapping function associated with the submitter-defined format.

45 The system of claim 40, wherein said means for converting said at least one business performance information file into a second data format comprises software instructions for analyzing said business performance data in accordance with at least one financial metric.

46. The system of claim 40, wherein said at least one financial metric is chosen from the group consisting of revenue growth, gross margins, EBIT and EBITDA margins, cash position and cash flow generation, debt to total capitalization ratio, funded debt to EBITDA ratio, interest coverage metrics, and other generally accepted accounting metrics.

47. The system of claim 45, further comprising means for generating one or more alerts in said second format if said at least one financial metric is below a predetermined threshold set by a requesting party for each of said metrics.

48. The system of claim 40, said means for receiving an indication from said submitter business of at least one requestor business authorized to view said information comprising means for receiving instructions from said submitter business indicating, for each authorized receiver business, a level selected from a plurality of levels of business performance information that a may be accessed by the receiver business.

49. The system of claim 40, said means for receiving an indication from said submitter business of at least one requestor business authorized to view said information comprising means for receiving instructions from said submitter business indicating, for each authorized receiver business, a time period of performance information for which the receiver business is authorized to view.

50. The system of claim 48, said means for displaying information contained in said at least one business performance information file to said authorized requestor comprising means for displaying information contained in said at least one business performance report based on said indicated level of business performance information for that authorized receiver business.

51. The system of claim 49, said means for displaying information contained in said at least one business performance information file to said authorized requestor comprising means for displaying information contained in said at least one business performance report based on said indicated time period of business performance information for that authorized receiver business.

52. A method for encouraging submitter businesses to share business performance information with requestor businesses through a business performance information sharing network comprising:
receiving at a data center computer system a request for business performance information of at least one submitter business;
sending an electronic request to at least one submitter business requesting authorization for the requester business to view business performance information corresponding to the at least one submitter business;
notifying said requestor business of a response to said electronic request; and
allowing said requester to view said business performance information based on submitter instructions included in a received response to said request.

53. The method according to claim 52, the step of receiving a request for business performance information of at least one submitter business comprising receiving a request from a requestor business via an interactive web page supplied by the data center computer system for business performance information on one or more participating submitter businesses.

54. The method according to claim 53, the step of sending an electronic message comprises sending an electronic mail message to at least one submitter business including a click through link to route the submitter business to the data center computer system.

55. The method according to claim 54, further comprising, once the submitter has been routed to the data center computer system, receiving from the submitter business an indication of whether the requestor business is authorized to view business performance information of that submitter.

56. The method according to claim 55, the step of receiving from the submitter an indication of whether the requester business is authorized to view business performance information of that submitter further comprising, if the requester is authorized, receiving an indication of a level of business performance information, from a plurality of levels, that may be viewed by the requester.

57. The method according to claim 55, the step of receiving from the submitter an indication of whether the requester business is authorized to view business performance information of that submitter further comprising, if the requestor is authorized, receiving an indication of a period of financial information from all available periods that may be viewed by the requester.

58. The method according to claim 56, the step of allowing said requester to view said business performance information based on submitter instructions comprising allowing said requestor to view said business performance information based on said indicated level of business performance information authorized for that requester business.

59. The method according to claim 57, the step of allowing said requestor to view said business performance information based on submitter instructions comprising allowing said requestor to view said business performance information based on said indicated period of business performance information authorized for that requestor business.

60. In a data center computer system, a computer readable storage medium containing computer readable instructions executable by a processor, said instructions configured to enable a submitter business to share business performance information with a requestor business comprising:
instructions for receiving a data upload comprising a file containing business performance data corresponding to a submitter in the form of a business performance information file in a first data format;
instructions for converting said business performance data in said business performance information file into a second data format;
instructions for requesting and receiving an indication of a requestor business authorized by said submitter business to view said business performance data;
instructions for notifying said requestor business that they have been authorized by the submitter business; and
instructions for displaying said business performance data to said authorized requestor business in said second data format.

61. The computer readable storage medium of claim 60, said instructions for converting said business performance data in said business performance information file into a second data format comprising instructions for converting a trial balance report from a submitter-defined format to a standardized format.

62. The computer readable storage medium of claim 61, said instructions for converting said trial balance report from a submitter-defined format to a standardized format comprising instructions for performing a mapping from the specific submitter-defined format to the standardized format using a predetermined mapping function associated with the submitter-defined format.

63. The computer readable storage medium of claim 60, said instructions for converting said business performance data in said business performance information file into a second data format comprising instructions for analyzing said business performance data in accordance with at least one financial metric.

64. The computer readable storage medium of claim 63, wherein said at least one financial metric is chosen from the group consisting of revenue growth, gross margins, EBIT and EBITDA margins, cash position and cash flow generation, debt to total capitalization ratio, funded debt to EBITDA ratio, interest coverage metrics, and other generally accepted accounting metrics.

65. The computer readable storage medium according to claim 63, said instructions for analyzing said business performance data in accordance with at least one financial metric further comprising instructions for generating one or more alerts in said second format if said at least one financial metric is below a predetermined threshold set by a requesting party for each of said metrics.

66. The computer readable storage medium of claim 60, said instructions for requesting and receiving an indication of a requestor business authorized by said submitter business to view said business performance data further comprising instructions for receiving from a submitter business an indication of a level chosen from a plurality of levels of business performance information that a may be accessed by the requestor business.

67. The computer readable storage medium of claim 60, said instructions for requesting and receiving an indication of a requestor business authorized by said submitter business to view said business performance data further comprising instructions for receiving from a submitter business an indication of a time period of business performance information that may be viewed by the requestor business.

68. The computer readable storage medium of claim 66, said instructions for displaying said business performance data to said authorized requester business in said second data format comprising instructions for displaying said business performance information in accordance with said indicated level of business performance information authorized for that requestor.

69. The computer readable storage medium of claim 67, said instructions for displaying said business performance data to said authorized requester business in said second data format comprising instructions for displaying said business performance information in accordance with said time period for business performance information authorized for that requester.
